(19) United States
(12) Patent Application Publication
(10) Pub. No.: US 2026/0072627 A1
(43) Pub. Date: Mar. 12, 2026

(54) STORAGE MEDIUM, INFORMATION PROCESSING APPARATUS, AND CONTROL METHOD OF INFORMATION PROCESSING APPARATUS

(71) Applicant: CANON KABUSHIKI KAISHA, Tokyo (JP)

(72) Inventor: KENTA MIYAO, Tokyo (JP)

(21) Appl. No.: 19/310,492

(22) Filed: Aug. 26, 2025

(30) Foreign Application Priority Data
Sep. 6, 2024 (JP) 2024-153692

(51) Int. Cl. G06F 3/12; H04L 41/069

(52) U.S. Cl. CPC G06F 3/1236; G06F 3/1205; G06F 3/126; H04L 41/069

(57) ABSTRACT

A control method of an information processing apparatus includes acquiring a plurality of zero-configuration-networking-service names registered in the information processing apparatus, and issuing, based on a fact that a first zero-configuration-networking-service name and a second zero-configuration-networking-service name match, a notification to prompt a user to change a zero-configuration-networking-service name of at least one of a first communication apparatus having the first zero-configuration-networking-service name and a second communication apparatus having the second zero-configuration-networking-service name, wherein the first zero-configuration-networking-service name and the second zero-configuration-networking-service name are from among the plurality of zero-configuration-networking-service names.

### BACKGROUND

### Field of the Technology

The present disclosure relates to a storage medium, an information processing apparatus, and a control method of the information processing apparatus.

### Description of the Related Art

Devices such as printers that include connection interfaces compliant with a standard referred to as Universal Serial Bus (USB) have been widely used. The USB standard allows a plurality of logical channels referred to as endpoints to be set. Different endpoints are assigned to different functions, such as print and scan functions, provided by a device such as a printer, and each function can be used by a host computer via a USB connection interface. Further, some printers include a web server function and/or an Internet Printing Protocol (IPP) function. In such printers, a setting can be changed via a network using a web browser or the like, and printing and scanning can be performed using IPP. Further, a communication standard referred to as IPP over USB is also defined. IPP over USB enables IPP, which is intended to be used over a TCP/IP network, to be used between a host computer and a printer connected via USB.

As software for controlling a printer that includes the above-described functions, printer-specific software (hereinafter, also referred to as “specific printer driver”) provided by a printer vendor is known. Further, a technology that enables an operating system (hereinafter, also referred to as “OS”) to provide a standard printing function (hereinafter, also referred to as “OS standard printing function”) without requiring a specific printer driver is also known.

In addition, the above-described OS standard printing function may employ a zero-configuration networking technology that enables a terminal or device, such as a computer or printer, to automatically connect to a network without manual intervention. Examples of this zero-configuration networking technology include Bonjour® developed by U.S.-based Apple Inc. Bonjour® is a service that runs on the Transmission Control Protocol/Internet Protocol (TCP/IP) and includes a function that automatically detects a device such as a terminal or printer connected to a local area network (LAN). Furthermore, Bonjour® also includes a function that searches the detected devices for a device capable of providing an intended service. Accordingly, the use of Bonjour® also enables, for example, automatic detection of a printer configured to provide IPP.

On the other hand, Bonjour® is primarily designed to detect a device configured to communicate via a network. Thus, it may be difficult for Bonjour® to detect a device connected to a host computer via a non-network connection interface, such as USB. However, Bonjour® may be able to detect a device (printer) connected to a host computer via a connection interface such as USB, if the target device (printer) supports the IPP over USB protocol.

As described above, technologies for enabling detection of a device that is difficult to detect using the basic Bonjour® configuration alone are described. Japanese Patent Laid-Open No. 2016-186774 describes a technology that detects a nearby printer using Wi-Fi Direct.

On the other hand, in a case where a device such as a printer using a connection different from a network connection, e.g., a connection interface such as USB, is permitted to connect, a plurality of devices different from each other may be configured with the same Bonjour® service name.

In this situation, if target device detection is performed by specifying a service name (identification information), such as Bonjour®, some devices may be difficult to detect.

### SUMMARY

Embodiments of the present disclosure are directed to enabling each device to be used in a more suitable configuration even in a situation where the plurality of devices may be configured with the same identification information.

According to an aspect of the present disclosure, a control method of an information processing apparatus includes acquiring a plurality of zero-configuration-networking-service names registered in the information processing apparatus, and issuing, based on a fact that a first zero-configuration-networking-service name and a second zero-configuration-networking-service name match, a notification to prompt a user to change a zero-configuration-networking-service name of at least one of a first communication apparatus having the first zero-configuration-networking-service name and a second communication apparatus having the second zero-configuration-networking-service name, wherein the first zero-configuration-networking-service name and the second zero-configuration-networking-service name are from among the plurality of zero-configuration-networking-service names.

Other features of various embodiments will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a system.

FIG. 2 is a diagram illustrating an example of a software configuration of a host computer.

FIG. 3 is a diagram illustrating an example of a process realized by a portal application.

FIG. 4 is a diagram illustrating an example of a process realized by the portal application.

FIG. 5 is a diagram illustrating an example of a user interface (UI) screen.

FIGS. 6A and 6B are diagrams illustrating examples of UI screens.

FIGS. 7A and 7B are diagrams illustrating an example of a process realized by the portal application.

FIG. 8 is a diagram illustrating an example of a UI screen.

FIGS. 9A and 9B are diagrams illustrating an example of a process realized by the portal application.

FIG. 10 is a diagram illustrating an example of a display screen of a remote UI.

FIG. 11 is a diagram illustrating an example of an information notification dialog box.

FIG. 12 is a diagram illustrating a structure of a Device Uniform Resource Identifier (Device URI).

FIG. 13 is a diagram illustrating an example of a configuration of a Uniform Resource Locator (URL) for a remote UI.

### DESCRIPTION OF THE EMBODIMENTS

Various example embodiments of the present disclosure will be described in detail below with reference to the attached drawings.

The embodiments described below are not intended to limit every embodiment and that not all combinations of features described in the embodiments are necessarily essential to the technical solutions provided by the present disclosure.

### <System Configuration>

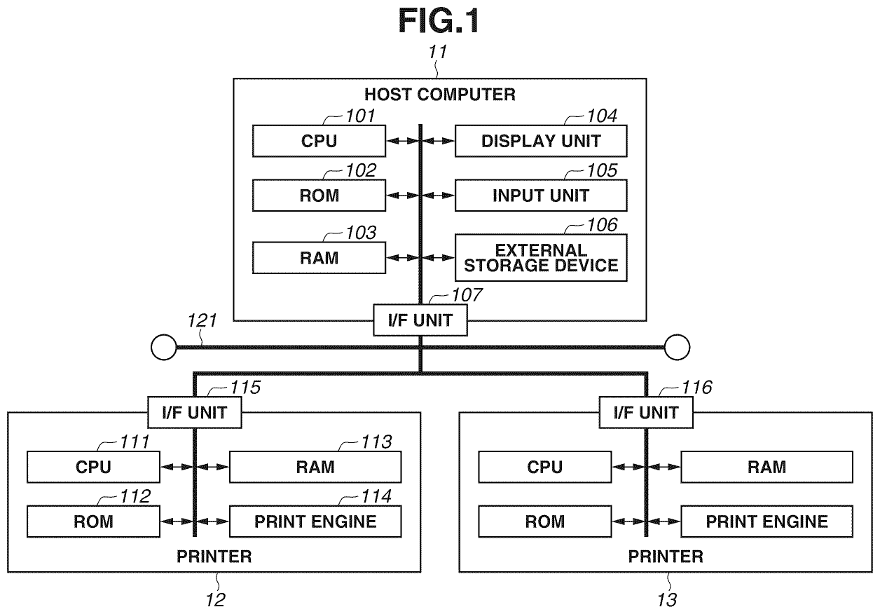

An example of a configuration of a system according to an embodiment of the present disclosure will be described with reference to FIG. 1. The system according to the present embodiment includes a host computer 11 and printers 12 and 13. Further, the host computer 11 and the printers 12 and 13 are connected to communicate with one another via a communication bus 121, such as Ethernet or USB. Although FIG. 1 illustrates an example of a case where two printers are connected to the host computer 11 via the communication bus 121, this is not intended to limit the configuration of the system according to the present embodiment, and three or more printers may be connected.

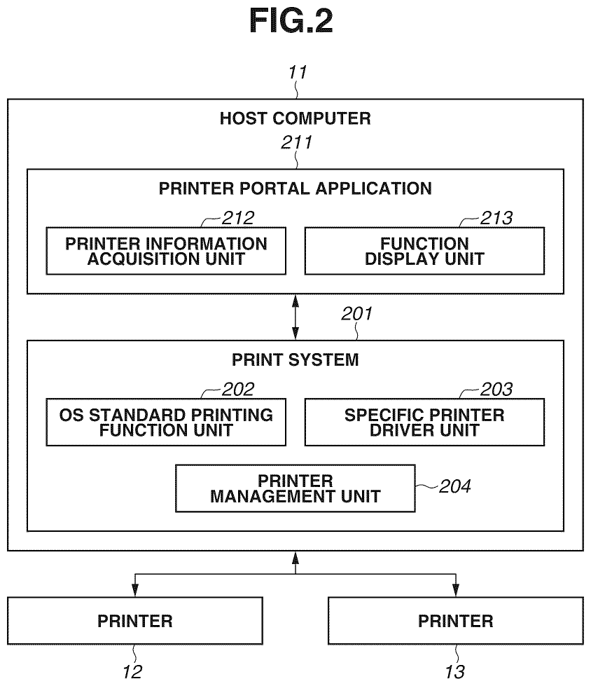

The host computer 11 corresponds to an example of an information processing apparatus according to the present embodiment. An operating system (hereinafter, also referred to as “OS”) is installed on the host computer 11. The OS includes an OS standard printing function unit 202, which is OS standard printing software. The OS standard printing function unit 202 will be described below with reference to FIG. 2.

The host computer 11 is realized by, for example, a personal computer (PC) and includes a central processing unit (CPU) 101, a read-only memory (ROM) 102, a random access memory (RAM) 103, a display unit 104, an input unit 105, an external storage device 106, and an interface (I/F) unit 107. The host computer 11 according to the present embodiment is not limited to a desktop PC and may be realized by a laptop PC, a tablet PC, or a smartphone.

The host computer 11 transmits, to each of the printers 12 and 13, an instruction for controlling an operation of the target printer, print data, and/or a setting command.

The CPU 101 is a central processing unit that controls each unit of the host computer 11 and executes control programs of the OS, an OS print data conversion utility, which will be described below, and the like.

The ROM 102 is a storage area that is realized by a read-only memory and stores a program, data, and the like used by the CPU 101 to control each unit of the host computer 11.

The RAM 103 is a storage area that is realized by a random access memory and used to temporarily store various types of data, and may be used as, for example, a work area of the CPU 101.

The display unit 104 is realized by a display apparatus, such as a display, and serves as an output interface that displays various types of information to present the information to a user. Specifically, for example, the display unit 104 may display input information received via the input unit 105, user interface screens of the OS and an application, various messages, and the like.

The input unit 105 is realized by an input apparatus, such as a keyboard, a mouse, or the like, and serves as an input interface that receives various instructions from the user to the host computer 11.

The external storage device 106 is realized by a storage device, such as a hard disk drive (HDD) or the like, and stores various control programs of the application, the OS print data conversion utility, and the like.

The I/F unit 107 is a communication module that performs data transmission and reception with external devices, such as the printers 12 and 13 and the like.

Each of the printers 12 and 13 is an example of an image forming apparatus that forms an image on a recording medium, such as paper. For example, an inkjet printer or the like may be applicable. Substantially the same configuration may be applied to each of the printers 12 and 13. Accordingly, only an example of a configuration of the printer 12 is described herein, and detailed descriptions of a configuration of the printer 13 will be omitted. The printer 12 includes a CPU 111, a ROM 112, a RAM 113, a print engine 114, and an I/F unit 115.

The CPU 111 is a central processing unit that controls the operation of each component of the printer 12 described below.

The ROM 112 is a storage area that is realized by a read-only memory and stores a control program of the print engine 114 and the like.

The RAM 113 is a storage area that is realized by a random access memory and used to temporarily store various types of data, and may store, for example, a program for controlling an operation of the print engine 114, a setting value received from the host computer 11, and the like.

The print engine 114 forms (i.e., prints) an image on a recording medium, such as paper, based on print data transmitted from the host computer 11.

The I/F unit 115 is a communication module that receives various types of data, such as print data, from the host computer 11. Further, the I/F unit 115 includes a function that transmits current status information about the printer 12 from the printer 12 to the host computer 11.

The status information corresponds to status data indicating a status of the printer 12. The status information is transmitted from the printer 12 to the host computer 11 in response to a request from the host computer 11 connected to the printer 12 via the I/F unit 115. The status data may include information for notifying various types of information, such as an operational status of the printer 12 (e.g., “printing”, “standby state”, or the like) and an error state of the printer 12 (e.g., “out of paper”, “the cover is opened”, “consumable depleted”, or the like). Further, the status data may also include information about the type of each consumable attached to the printer 12, a display color for each consumable, a remaining level for each consumable, and the like.

Since a configuration substantially the same as that of the I/F unit 115 of the printer 12 may be applied to an I/F unit 116 of the printer 13, detailed descriptions of the I/F 116 will be omitted.

### <Software Configuration>

An example of a software configuration of the host computer 11 according to the present embodiment will be described with reference to FIG. 2.

The host computer 11 according to the present embodiment includes a print system 201 configured to provide a printing function. Further, the print system 201 includes the OS standard printing function unit 202, a specific printer driver unit 203, and a printer management unit 204.

Each of the OS standard printing function unit 202 and the specific printer driver unit 203 is software configured to convert data output from the application into data for printing by a printer and thereafter cause the printer to perform printing based on the data.

A target printer is pre-registered via the printer management unit 204 to enable the use of the printer via the print system 201. This registration process is performed for each printer or each connection type. For example, the same printer may be registered and managed for a USB connection type (hereinafter, also referred to as “USB connection”) and for a network connection type (hereinafter, also referred to as “network connection”), such as LAN.

Further, the host computer 11 includes a printer portal application 211. The printer portal application 211 includes a printer information acquisition unit 212 and a function display unit 213.

The printer portal application 211 is software configured to perform a process of acquiring information about the printer 12, printing, scanning, and the like based on a user instruction, a printer connection status, and the like.

The printer information acquisition unit 212 acquires device information about a printer (e.g., the printer 12 or 13 or the like). Specifically, for example, the printer information acquisition unit 212 may acquire device information about a printer registered in the printer management unit 204.

The function display unit 213 displays various types of information, such as device information about a printer acquired by the printer information acquisition unit 212, in a predetermined display area to present the information to the user. Further, the function display unit 213 may include a function that displays a webpage based on device information about a printer acquired by the printer information acquisition unit 212. Examples of a webpage displayed based on device information about a printer by the function display unit 213 include a webpage (hereinafter, also referred to as “remote UI”) that enables a web browser to change a setting for the printer via a network.

### <Overview of the Printer Management Unit of the Print System>

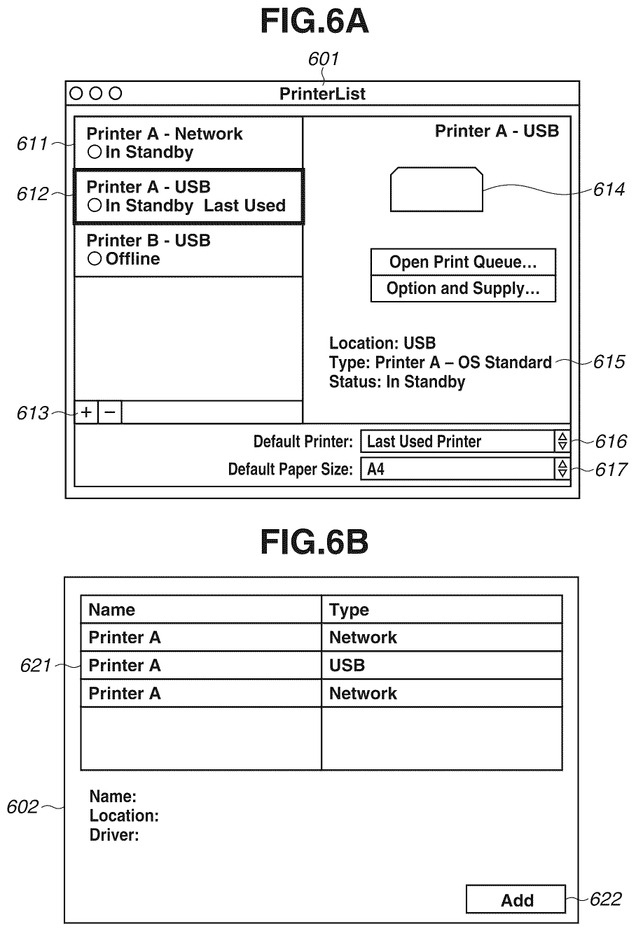

An overview of the printer management unit 204 of the print system 201 according to the present embodiment will be described. FIGS. 6A and 6B are diagrams illustrating examples of screens provided by the printer management unit 204. A main window 601 illustrated in FIG. 6A may be displayed, for example, based on an instruction from the user via a standard system settings application that runs on macOS® of U.S.-based Apple Inc. The main window 601 includes a printer list section 611, a printer register/unregister button 613, a printer preview section 614, a printer information section 615, a default printer setting unit 616, and a default paper size setting unit 617.

To register a printer in the print system, for example, an instruction to register the printer from the user is received via a “+” button of the printer register/unregister button 613. In a case where the “+” button is pressed, a connection printer list window 602 of the printer management unit 204 illustrated in FIG. 6B is displayed.

A connection printer list section 621 of the connection printer list window 602 displays a list presenting information about each printer currently connected to the host computer 11. In this case, information about a printer that supports a plurality of connection types is displayed separately for each connection type. Specifically, for example, in a case where a printer can use a network connection and a USB connection, information corresponding to the network connection and information corresponding to the USB connection are displayed separately in the connection printer list section 621. Various descriptions in the present embodiment are based on a case where a technology referred to as Bonjour® provided by U.S.-based Apple Inc. is applied for detection of a printer currently connected to the host computer 11.

In a case where a printer with information displayed in the connection printer list section 621 is selected based on a user operation and a registration button 622 is pressed, a process of registering the selected printer in the printer management unit 204 is performed. In a case where this printer registration process is successful, the connection printer list window 602 of the printer management unit 204 is closed, and a queue of the registered printer is displayed in the printer list section 611 of the main window 601. For example, in the example illustrated in FIG. 6A, the queue of the registered printer is displayed in an area 612. A Bonjour® service name is displayed as a name displayed in the connection printer list section 621 in the example illustrated in FIG. 6A. Further, for a network connection printer, a Bonjour® service name configured on the printer (main unit) is displayed as a name displayed in the connection printer list section 621. On the other hand, for a USB connection printer, a default Bonjour® service name is displayed regardless of the settings configured on the printer (main unit) due to the Bonjour® specifications.

Each printer displayed in the printer list section 611 of the printer management unit 204 is a printer queue registered in the print system 201 and corresponds to a printer capable of performing printing and scanning. In a case where a printer to be used is selected by the user via the printer list section 611, a preview image indicating the selected printer is displayed in the printer preview section 614. Further, information indicating the connection type (USB), the OS standard printing function unit, the printer status (in standby), and the like is displayed in the printer information section 615.

As illustrated in FIG. 1, in a case where the printer 12 is connected to the host computer 11 via USB, the printer registration process in the printer management unit 204 is automatically performed, and the printer 12 is registered in the printer list section 611 of the main window 601. Thereafter, a default Bonjour® service name of the printer 12 is configured as a Bonjour® service name of the printer 12 registered in the printer list section 611.

A model name of a printer may be configured as a default Bonjour® service name of the printer. In this situation, for example, in a case where the printers 12 and 13 are of the same model, the same name may be configured as default Bonjour® service names for the printers 12 and 13.

Specifically, for example, the printer 12 having a connection type that is a network connection and the printer 13 having a connection type that is a USB connection exist, and the default Bonjour® service name is used as the Bonjour® service name of the printer 12. In this situation, if the printer 12 is registered first in the printer list section 611 and thereafter the printer 13 is registered in the printer list section 611, both the printers 12 and 13 are registered with the same Bonjour® service name.

The print system 201 stores printer queue name and Device URI information for each printer queue registered in the printer management unit 204.

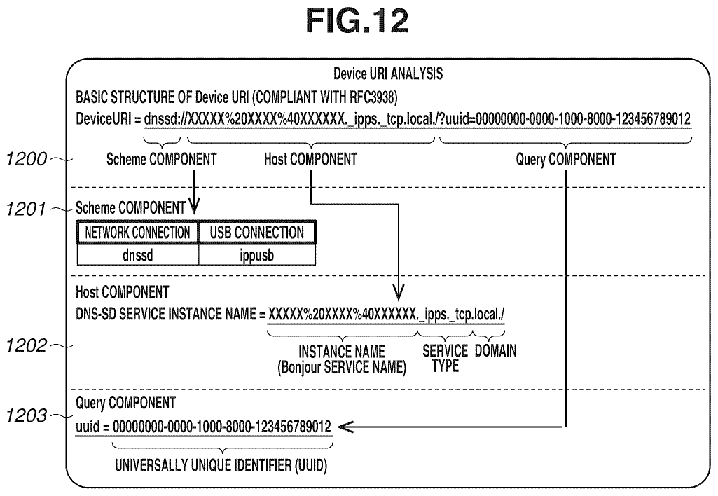

A Device URI will be described with reference to FIG. 12. A Device URI is a uniform resource identifier that is uniquely configured for a device to identify the device and is compliant with the URI basic structure defined in Request for Comments (RFC) 3986. Accordingly, a Device URI can be divided into Scheme, Host, and Query components, as specified in a section 1200 in FIG. 12.

A character string included in the Scheme component of the Device URI distinguishes between a USB connection printer and a network connection printer, as specified in a section 1201. Accordingly, the connection type at the time of registration in the printer management unit 204 can be determined by analyzing the Scheme component.

Further, the Host component is a service instance name of a Domain Name System-based service discovery (hereinafter, also referred to as “DNS-SD”). The Host component is composed of a Bonjour® service name (instance name), service type, and domain, as specified in a section 1202.

The Query component includes a Universally Unique Identifier (hereinafter, also referred to as “UUID”), as specified in a section 1203. The UUID is used as a universally unique identifier of each printer (i.e., identification information for identifying each printer).

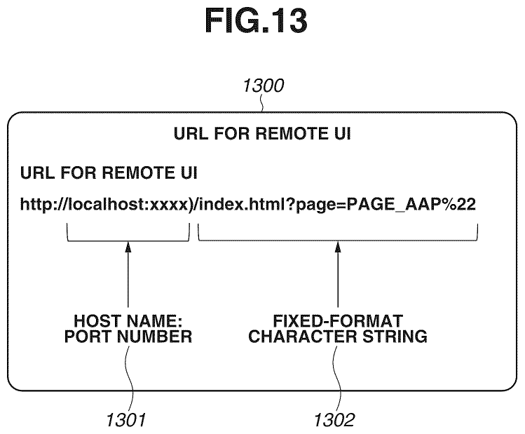

Further, the print system 201 includes a function that displays a remote UI of a printer for which the printer information acquisition unit 212 has acquired information. FIG. 13 illustrates an example of a configuration of a URL for the remote UI. As illustrated in FIG. 13, a URL 1300 for the remote UI is composed of a host name and port number 1301 and a fixed-format character string 1302.

### First Embodiment

A first embodiment of the present disclosure will be described. There is a situation where a plurality of separate printers configured with the same Bonjour® service name is connected to the host computer 11. Furthermore, the host computer 11 is connected to the plurality of printers via different interfaces. Specifically, the different interfaces are, for example, an interface for connecting via USB (hereinafter, also referred to as “USB IF”) and an interface for connecting via wireless LAN (hereinafter, also referred to as “wireless LAN IF”). The plurality of printers corresponds to the printers 12 and 13, and the printers 12 and 13 are connected to the host computer 11 via the USB IF and the wireless LAN IF, respectively. Hereinafter, this situation will be referred to as the specific situation.

Further, the OS on the host computer 11 also acquires other information from a printer when acquiring a Bonjour® service name from the printer, and the Bonjour® service name and the other information are managed in association with each other. The printer portal application 211 on the host computer 11 notifies a Bonjour® service name to the OS on the host computer 11 to acquire information managed in association with the notified Bonjour® service name from the OS. Specifically, the other information is, for example, a URL for displaying a screen (a remote UI described below) for configuring various settings for the printer.

However, in a case where the printer portal application 211 notifies the Bonjour® service name of the printer 12 to the OS in the specific situation in an attempt to acquire the other information about the printer 12, since the OS also manages the Bonjour® service name of the printer 13, which is the same as the Bonjour® service name of the printer 12, the printer portal application 211 may acquire not the other information about the printer 13 but the other information about the printer 12. As a result, for example, a URL for displaying a screen for configuring various settings for the printer 13 may be acquired, even though an attempt has been made to acquire a URL for displaying a screen for configuring various settings for the printer 12. In other words, in the specific situation, since the OS manages a plurality of items of information with the same Bonjour® service name, it may be difficult for an information acquisition function (Bonjour® service detection function) using a Bonjour® service name to acquire information desired by the user. The information desired by the user refers to, for example, information about a printer selected as a communication target, which will be described below. This is because the user has selected a communication target printer.

In a case where a Bonjour® service name notified by the application 211 is managed in association with both a printer connected via the USB IF and a printer connected via the wireless LAN IF, the OS notifies the application 211 of information about the printer connected via the wireless LAN IF in preference to information about the printer connected via the USB IF. The case where a Bonjour® service name notified by the application 211 is managed in association with both a printer connected via the USB IF and a printer connected via the wireless LAN IF refers to a case where the Bonjour® service name acquired from the printer connected via the USB IF and the Bonjour® service name acquired from the printer connected via the wireless LAN IF are the same. Accordingly, if the information desired by the user is the information about the printer connected via the wireless LAN IF, the application 211 may acquire the information desired by the user even in the specific situation. In other words, a case where it may be difficult to acquire the information desired by the user is mainly a case where the information desired by the user is the information about the printer connected via the USB IF.

Considering the above-described situation, the present embodiment describes an example of a technology that prompts the user to change the Bonjour® service name in the specific situation in an attempt to solve the issue.

The plurality of separate printers configured with the same Bonjour® service name may be connected to the host computer 11 via the same interface. In this situation, the OS manages information after at least one of the Bonjour® service names acquired from the printers has been partially changed. As a result, the OS manages different Bonjour® service names in association with the printers, and the printer portal application 211 acquires the different Bonjour® service names. Therefore, the issue that occurs in the specific situation does not arise.

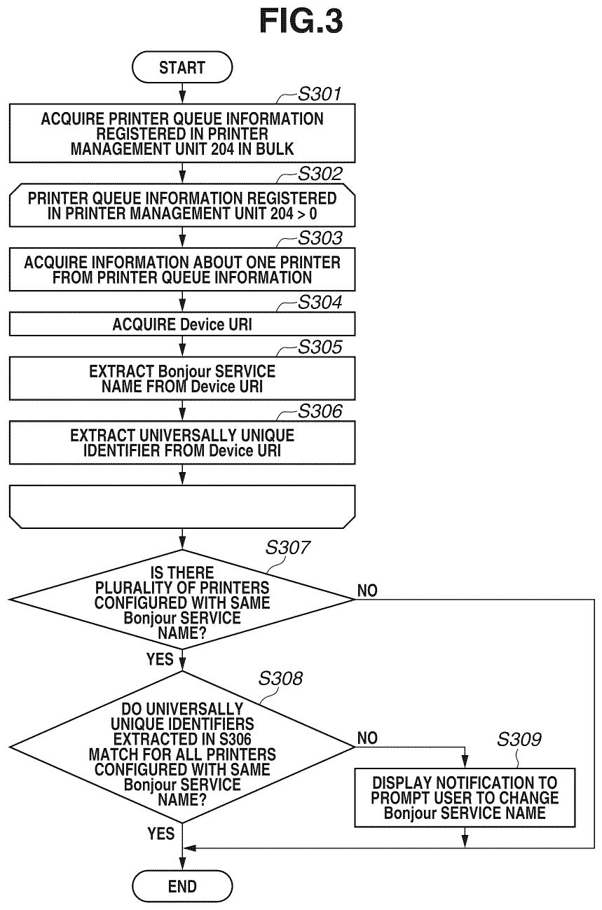

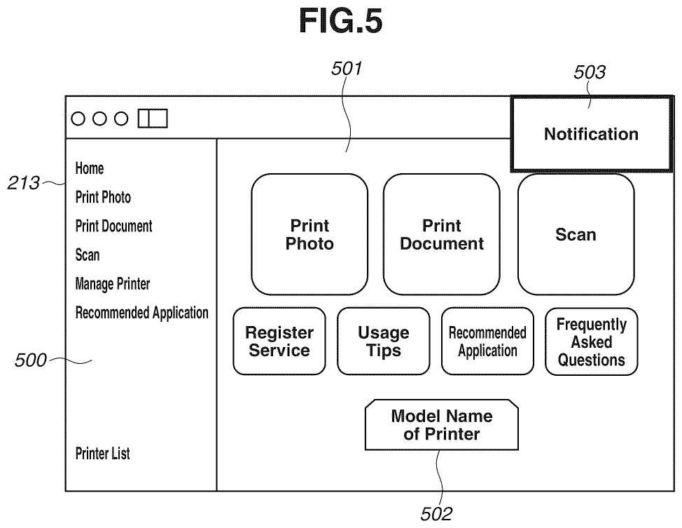

As an example of a process realized by the printer portal application 211, a process in which the printer information acquisition unit 212 acquires printer information registered in the printer management unit 204 and notifies information to the user based on the acquisition result will be described with reference to FIG. 3. The process illustrated in FIG. 3 will be described also with reference to FIG. 5. FIG. 5 illustrates an example of a UI screen generated by the function display unit 213 of the printer portal application 211. The UI screen includes a taskbar 500, a function shortcut placement area 501, a selected printer information 502, and a notification area 503 for prompting a change of the Bonjour® service name. In the notification area 503, a notification for prompting a change of the Bonjour® service name or the like is displayed. Although software and a function block may be described as a processing component for convenience, in practice, the corresponding function may be realized by the CPU 101 executing the corresponding program.

Once the printer portal application 211 is launched, in step S301, the printer portal application 211 acquires printer queue information registered in the printer management unit 204 in bulk from the OS. The printer queue information acquired herein is information managed by the OS. Further, the printer queue information is composed of information acquired from a printer previously connected to the host computer 11 and information acquired from a printer currently connected to the host computer 11. The process for acquiring printer queue information registered in the printer management unit 204 may be performed not only at the time of an application launch but also at other times. Examples of a start time of the process of step S301 include a time of a transition to another screen in response to a user operation on a UI of the printer portal application 211. Further, the application 211 acquires printer queue information from the OS, thereby enabling a printer corresponding to the printer queue information to be registered in the application 211. Further, the application 211 receives a user selection of a printer from the plurality of printers registered in the application 211, thereby enabling the communication target printer to be selected. Thereafter, with the communication target printer being selected, the application 211 can display a button for displaying a screen for configuring various settings for the communication target printer using a remote UI function of the communication target printer. Accordingly, for example, the process of step S301 may be performed when the button is operated. Further, for example, an OS standard function can be used to acquire printer queue information. Further, the process of step S301 may be performed in a case where a plurality of printers is registered in the printer management unit 204. Further, the information acquired in step S301 includes the Bonjour® service name of the printer, which is a first type of identification information, and the Device URI of the printer, which is a second type of identification information.

Next, the printer portal application 211 iterates a loop process in step S302, which includes the processes from step S303 to step S306, for each item of printer queue information acquired in step S301 as a processing target. The processes from step S303 to step S306 will be described in detail.

In step S303, the printer portal application 211 extracts information about individual printers from the printer queue information acquired in bulk in step S301. Specifically, for example, in a case where the printers 12 and 13 are registered in the printer management unit 204, printer queue information about the printer 12 and printer queue information about the printer 13 are acquired in step S301. In this case, the printer portal application 211 extracts the set of printer queue information corresponding to the printer 12 or 13 that is the processing target printer (e.g., the printer 12).

In step S304, the printer portal application 211 acquires the Device URI of the processing target printer from the set of printer queue information about the processing target printer extracted in step S303. The Device URIs of the plurality of separate printers correspond to different content. The identification information acquired herein is not limited to the Device URI and may be any information that provides different content for each of the plurality of separate printers. For example, the identification information acquired herein may be a serial number or the like. In this case, the printer portal application 211 may also acquire printer queue information other than the Device URI from the set of printer queue information extracted in step S303. Examples of target printer information managed as printer queue information include a printer name, model name, and the like.

In step S305, the printer portal application 211 extracts the Bonjour® service name set for the target printer from the Device URI acquired in step S304. Specifically, the printer portal application 211 may extract the instance name described in the Host component of the Device URI as the Bonjour® service name, as described above with reference to FIG. 12.

In step S306, the printer portal application 211 extracts the universally unique identifier of the target printer from the Device URI acquired in step S304. Specifically, the printer portal application 211 may extract the universally unique identifier from the Query component of the Device URI, as described above with reference to FIG. 12. Each of the universally unique identifiers of the plurality of separate printers corresponds to different content.

In a case where the printer portal application 211 completes the loop process in step S302, the processing proceeds to step S307.

In step S307, the printer portal application 211 determines whether there is a plurality of printers configured with the same Bonjour® service name, based on the Bonjour® service name extraction results for the printers in step S305. Hereinafter, the same Bonjour® service name shared by the separate printers will be referred to as a specific Bonjour® service name.

In a case where the printer portal application 211 determines that there is not a plurality of printers configured with the same Bonjour® service name (NO in step S307), the process illustrated in FIG. 3 is terminated. In this case, the Bonjour® service detection function can be used without any issues.

On the other hand, in a case where the printer portal application 211 determines that there is a plurality of printers configured with the same Bonjour® service name (YES in step S307), the processing proceeds to step S308.

In step S308, the printer portal application 211 determines whether the universally unique identifiers of all printers configured with the same Bonjour® service name match.

This process is a process for determining whether a plurality of identical Bonjour® service names is acquired from a plurality of separate printers because the host computer 11 is connected to the plurality of separate printers configured with the same Bonjour® service name via different interfaces, or the plurality of identical Bonjour® service names is acquired from one printer because the host computer 11 is connected to one printer via two interfaces.

In a case where the printer portal application 211 determines that the universally unique identifiers of all the printers configured with the same Bonjour® service name match (YES in step S308), the process illustrated in FIG. 3 is terminated. In this case, the Bonjour® service detection function can be used without any issues.

On the other hand, in a case where the printer portal application 211 determines that at least some of the universally unique identifiers of the plurality of printers configured with the same Bonjour® service name do not match (NO in step S308), the processing proceeds to step S309. In this case, as described above, it may be difficult to acquire information desired by the user using the Bonjour® service detection function.

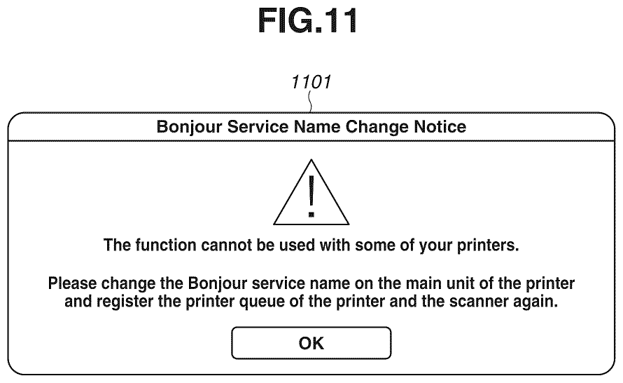

In step S309, the printer portal application 211 issues a notification to prompt the user to change the Bonjour® service name of at least one of the plurality of printers configured with the same Bonjour® service name. For example, FIG. 11 illustrates an example of a dialog box 1101, which is a screen displayed in a predetermined display area by the printer portal application 211 to prompt the user to change the Bonjour® service name. Prompting the user to change the Bonjour® service name of the printer as described above is expected to result in a state where the Bonjour® service name is changed and it becomes possible for the application 211 to acquire information about the printer from the OS using the Bonjour® service detection function.

The screen displayed in step S309 may include information indicating a printer for which the Bonjour® service name should be changed. Specifically, for example, a specific Bonjour® service name may be displayed on the screen displayed in step S309. Since the Bonjour® service name is the model number of the printer in the present embodiment, displaying the Bonjour® service name enables the user to identify the printer for which the Bonjour® service name should be changed. Further, the screen displayed in step S309 may include a sentence to prompt the user to change the Bonjour® service name of one of the plurality of printers connected to the host computer 11 and having the same model number. Further, the screen displayed in step S309 may include a sentence indicating a method for changing the Bonjour® service name. Specifically, the method for changing the Bonjour® service name refers to, for example, a method in which a predetermined operation is performed on the printer to change the Bonjour® service name or a method in which an operation is performed on a screen displayed by a remote UI. The remote UI will be described in detail in a second embodiment.

### Second Embodiment

The second embodiment of the present disclosure will be described. The description of the present embodiment focuses on the portions that differ from the first embodiment described above, and detailed descriptions of the portions that are substantially the same as the first embodiment will be omitted.

As described above, in a case where separate printers are configured with the same Bonjour® service name and some of the printers have a connection type that is a USB connection, it is difficult to identify a USB connection printer using Bonjour®. In this situation, for the USB connection printer, it may be difficult to use a function based on the premise that information is acquired using the Bonjour® service detection function.

Considering the above-described situation, the present embodiment describes an example of a case where a remote UI is displayed on a network connection printer that can be detected using the Bonjour® service detection function, and a notification is issued to prompt the user to change the Bonjour® service name.

The remote UI refers to a screen for configuring various settings for the printer and is displayed on a web browser based on screen information acquired from the printer by inputting the URL to the web browser.

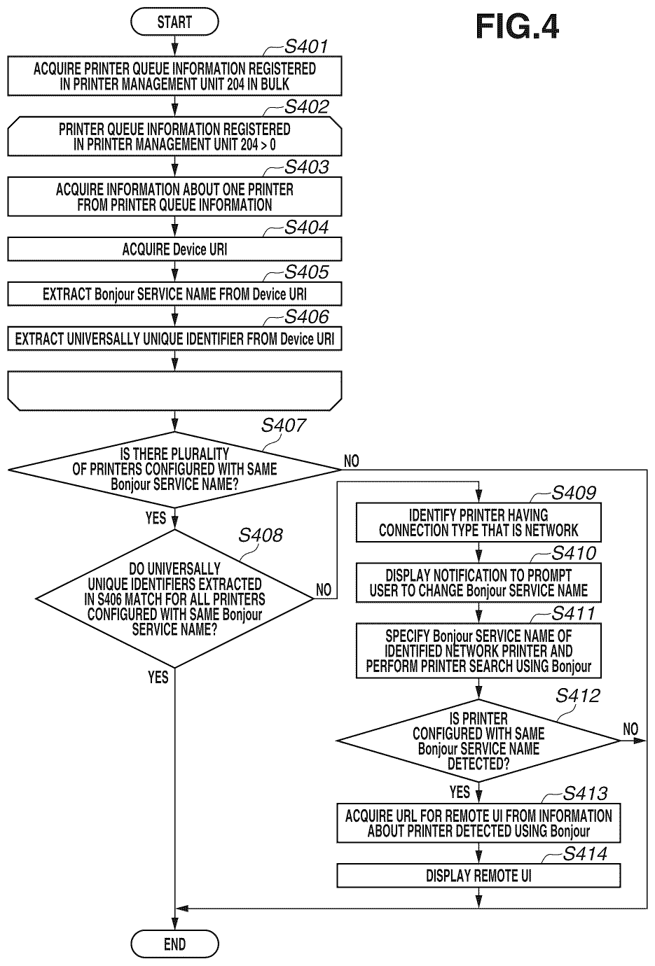

As an example of a process realized by the printer portal application 211, a process in which a remote UI of a network connection printer detected using the Bonjour® service detection function is displayed to prompt a change of the Bonjour® service name will be described with reference to FIG. 4.

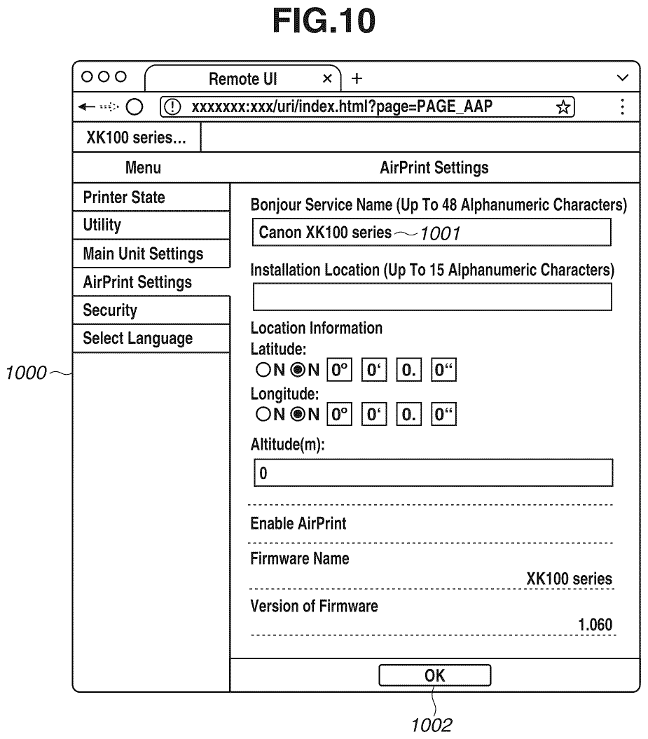

The process illustrated in FIG. 4 will be described also with reference to FIG. 10. FIG. 10 is a diagram illustrating an example of a remote UI screen 1000 of a network connection printer that is displayed as a result of performing the process illustrated in FIG. 4. The remote UI screen 1000 includes a Bonjour® service name input section 1001 for receiving input of a Bonjour® service name to be configured and a configured information confirmation section 1002. Although software and a function block may be described as a processing component for convenience, in practice, the corresponding function may be realized by the CPU 101 executing the corresponding program.

The processes from step S401 to step S408 are substantially the same as the processes from step S301 to step S308 in the first embodiment described above with reference to FIG. 3, so that detailed descriptions thereof will be omitted. Thereafter, in the present embodiment, in a case where the printer portal application 211 determines that at least some of the universally unique identifiers of the plurality of printers configured with the same Bonjour® service name do not match (NO in step S408), the processing proceeds to step S409.

In step S409, the printer portal application 211 identifies, from the plurality of printers configured with the same Bonjour® service name, a printer having a connection type that is a network connection. Whether the connection type of each printer is a network connection or USB connection can be determined based on, for example, the description in the Scheme component of the Device URI acquired in step S404, as described above with reference to FIG. 12.

This determination method is merely an example and not intended to be limiting, and any method capable of determining the connection type of the target printer may be used.

In step S410, the printer portal application 211 issues a notification to prompt the user to change the Bonjour® service name. The process of step S410 is substantially the same as the process of step S309 illustrated in FIG. 3.

In step S411, the printer portal application 211 specifies the Bonjour® service name of the printer identified as having a network connection in step S409 and performs a search for a printer configured with the Bonjour® service name. At this time, the printer portal application 211 may add the service type and/or domain extracted in step S305 to the search condition in addition to the Bonjour® service name.

In step S412, the printer portal application 211 determines whether a printer configured with the Bonjour® service name specified in step S411 is detected.

In a case where the printer portal application 211 determines that a printer configured with the specified Bonjour® service name is not detected (NO in step S412), the process illustrated in FIG. 4 is terminated. In this case, since it is difficult to acquire URL information about the remote UI for changing the setting for the target printer via a network, the printer portal application 211 terminates the process.

On the other hand, in a case where the printer portal application 211 determines that a printer configured with the specified Bonjour® service name is detected (YES in step S412), the processing proceeds to step S413.

In step S413, the printer portal application 211 acquires, from the printer queue information about the printer detected using Bonjour® in step S411, URL information about the remote UI for changing the setting for the printer via a network.

In step S414, the printer portal application 211 displays the remote UI of the target printer on the web browser being operated by the user, based on the URL information acquired in step S413.

Applying the foregoing control makes it possible to prompt the user to change the Bonjour® service name of the network connection printer. Further, changing the Bonjour® service name by the user via the remote UI is expected to result in a state where it is possible to acquire information desired by the user using the Bonjour® service detection function.

### Third Embodiment

A third embodiment of the present disclosure will be described. The description of the present embodiment focuses on the portions that differ from the first and second embodiments described above, and detailed descriptions of the portions that are substantially the same as the first and second embodiments will be omitted.

In a case where a network connection printer (A) and a USB connection printer (B), which are separate printers, are configured with the same Bonjour® service name, it may be difficult to identify the USB connection printer using Bonjour®. In such a case, the use of the function based on the premise that information is acquired using the Bonjour® service detection function may be restricted.

The present embodiment will describe an example of a system for solving such an issue. Specifically, according to the present embodiment, in a case where a Bonjour® service name of a network connection printer that can be detected using the Bonjour® service detection function is changed, this change is detected by the printer portal application 211. Thereafter, the printer portal application 211 notifies the user that the Bonjour® service name has been changed and printer queue re-registration is necessary, via the UI.

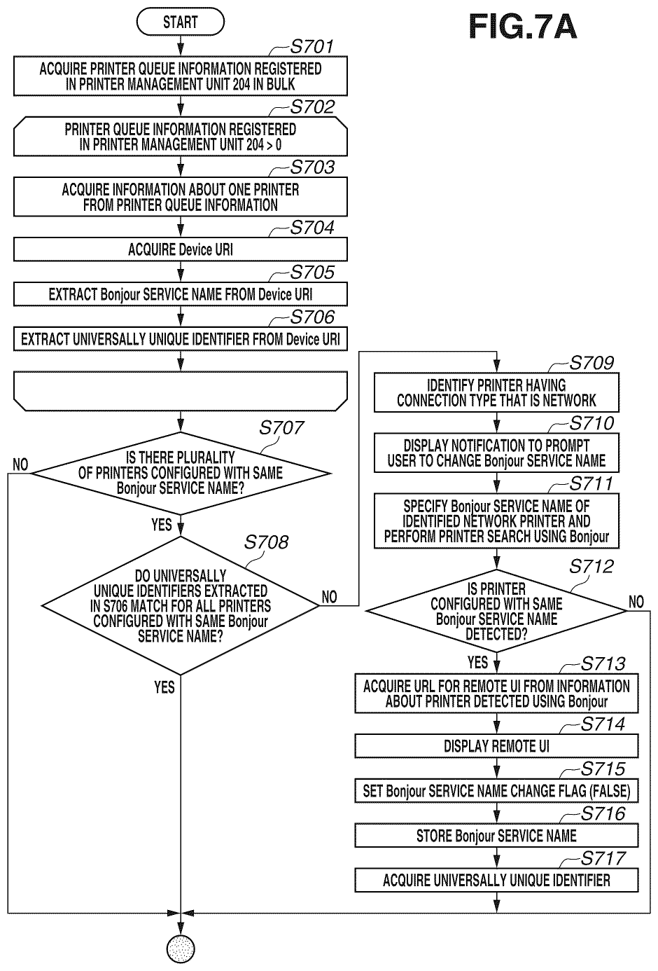

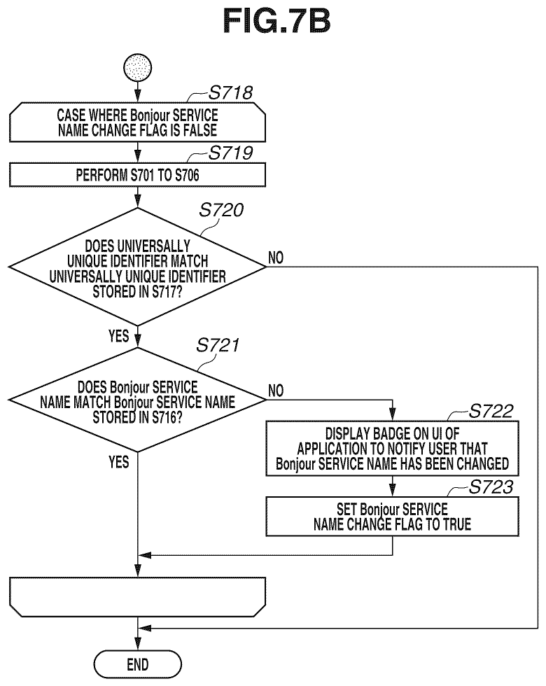

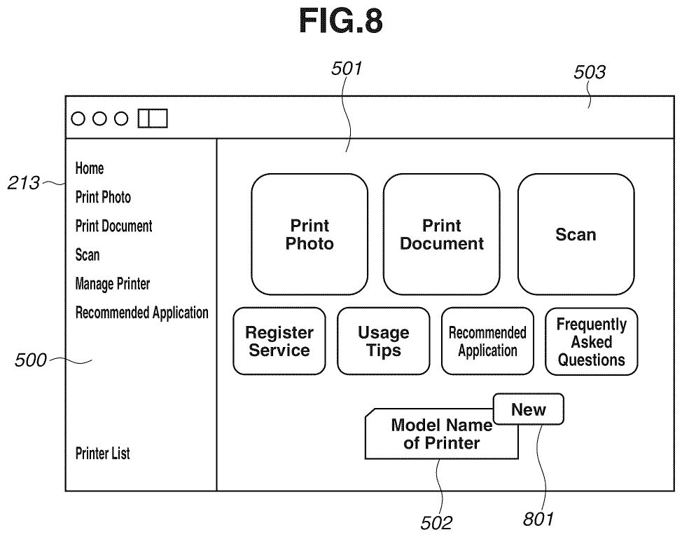

A process for displaying a badge to notify the change of the Bonjour® service name on the UI of the printer portal application 211 in a case where the Bonjour® service name is changed will be described in detail below with reference to FIG. 7. Further, an example of the UI of the printer portal application 211 for notifying the user that the Bonjour® service name has been changed and printer queue re-registration is necessary will be described in detail below with reference to FIG. 8. Further, the remote UI is as described above with reference to FIG. 10. Although software and a function block may be described as processing components for convenience, in practice, the corresponding function may be realized by the CPU 101 executing the corresponding program.

First, a process illustrated on the left part of FIG. 7 will be described. The processes of step S701 to step S714 are substantially the same as the processes of step S401 to step S414 in the second embodiment described above with reference to FIG. 4, so that detailed descriptions thereof will be omitted. In the process illustrated on the left part of FIG. 7, when the remote UI page is displayed in step S714, the printer portal application 211 stores the Bonjour® service name and the universally unique identifier of the printer identified in step S709.

Specifically, in step S715, the printer portal application 211 sets a Bonjour® service name change flag to FALSE. The Bonjour® service name change flag set herein is a flag that indicates whether the Bonjour® service name of the network connection printer detected in step S709 has been changed.

In step S716, the printer portal application 211 stores the Bonjour® service name of the network connection printer detected in step S709 in a predetermined storage area.

In step S717, the printer portal application 211 stores the universally unique identifier of the network connection printer detected in step S709 in a predetermined storage area.

Next, a process illustrated on the right part of FIG. 7 will be described. In the process illustrated on the right part of FIG. 7, primarily, in a case where the Bonjour® service name of the printer identified in step S709 is changed, a badge is displayed on the UI of the printer portal application 211 to notify that the Bonjour® service name has been changed.

Specifically, the printer portal application 211 iterates a loop process in step S718, which includes the processes from step S719 to step S723, as long as the Bonjour® service name change flag set in step S715 is FALSE. There are no restrictions on the timing of sequential execution of the processes from step S719 to step S723. For example, the processes from step S719 to step S723 do not need to be performed repeatedly immediately and may be performed in a case where a predefined user action is detected.

Specifically, for example, the processes from step S719 to step S723 may be performed at the time of a screen transition at the press of a printer icon displayed on the selected printer information 502 on the UI screen illustrated in FIG. 5. Further, as another example, the processes from step S719 to step S723 may be performed at the time of printer registration in the printer list section 611 of the main window 601 illustrated in FIG. 6A. Further, as yet another example, the processes from step S719 to step S723 may be performed at the time of launch or relaunch of the printer portal application 211.

In step S719, the printer portal application 211 performs processes that are substantially the same as the processes from step S701 to step S706, thereby acquiring the Device URI of each printer and extracting the Bonjour® service name and the universally unique identifier from the Device URI.

In step S720, the printer portal application 211 reads the universally unique identifier of the network connection printer stored in the predetermined storage area in step S717. Thereafter, the printer portal application 211 determines whether the universally unique identifier matches the universally unique identifier of each printer extracted in step S719.

In a case where the printer portal application 211 determines that a printer with the matching universally unique identifier is not detected (NO in step S720), the process illustrated on the left part of FIG. 7 is terminated. In this case, there are no printers with an issue.

On the other hand, in a case where the printer portal application 211 determines that a printer with the matching universally unique identifier is detected (YES in step S720), the processing proceeds to step S721.

In step S721, the printer portal application 211 reads the Bonjour® service name of the network connection printer stored in the predetermined storage area in step S716.

Thereafter, the printer portal application 211 determines whether the read Bonjour® service name matches the Bonjour® service name of each printer extracted in step S719.

In a case where the printer portal application 211 determines that a printer with the matching Bonjour® service name is detected (YES in step S721), the processing returns to the beginning of the loop process in step S718. In this case, since the Bonjour® service name of the target printer has not been changed, the loop process is performed again from the beginning.

On the other hand, in a case where the printer portal application 211 determines that a printer with the matching Bonjour® service name is not detected (NO in step S721), the processing proceeds to step S722. In this case, the Bonjour® service name of the target printer has been changed.

In step S722, the printer portal application 211 displays a badge 801 illustrated as an example in FIG. 8 on the UI screen to notify the user that the Bonjour® service name has been changed. Although visual information such as a badge is displayed in the example illustrated in FIG. 8 to notify the user that the Bonjour® service name has been changed, there are no restrictions on the method of displaying notification information, the direction of presentation, the display position, and the like.

In step S723, since the Bonjour® service name of the network connection printer identified in step S709 has been changed, the printer portal application 211 sets the Bonjour® service name change flag to TRUE.

Applying the foregoing control enables the user to visually recognize that the Bonjour® service name has been changed but the change of the Bonjour® service name has not been applied to the printer portal application 211. Accordingly, it can be expected that the user re-registers the network connection printer identified in step S709 via the printer register/unregister button 613 of the main window 601 illustrated in FIG. 6A.

### Fourth Embodiment

A fourth embodiment of the present disclosure will be described. The description of the present embodiment focuses on the portions that differ from the first, second, and third embodiments described above, and detailed descriptions of the portions that are substantially the same as the first, second, and third embodiments will be omitted.

As described above, in a case where separate printers are configured with the same Bonjour® service name and some of the printers have a connection type that is a USB connection, it is difficult to identify a USB connection printer using Bonjour®. In this situation, for the USB connection printer, it may be difficult to use a function based on the premise that information is acquired using the Bonjour® service detection function.

Considering the above-described situation, the present embodiment describes an example of a technology that enables the use of some of the functions that are subject to usage restrictions on a USB connection printer for which it is difficult to identify information using Bonjour®. The present embodiment provides various descriptions that focus on a case where the use of the function for displaying a remote UI that enables printer configuration via a network as in the process of step S714 in FIG. 7 is enabled.

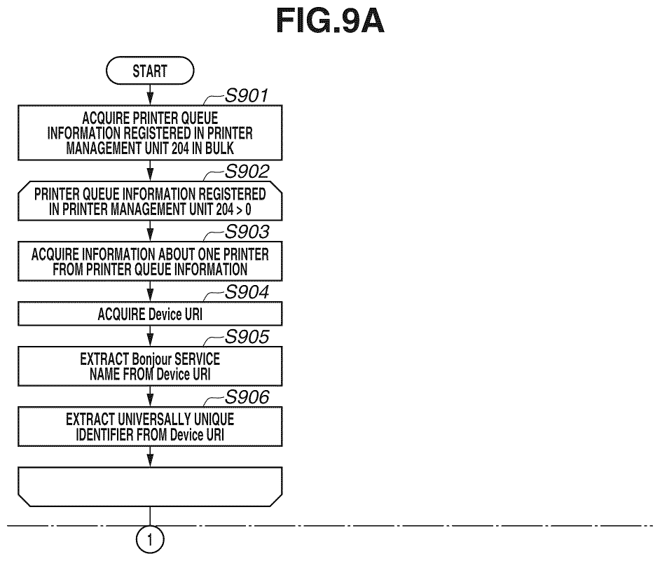

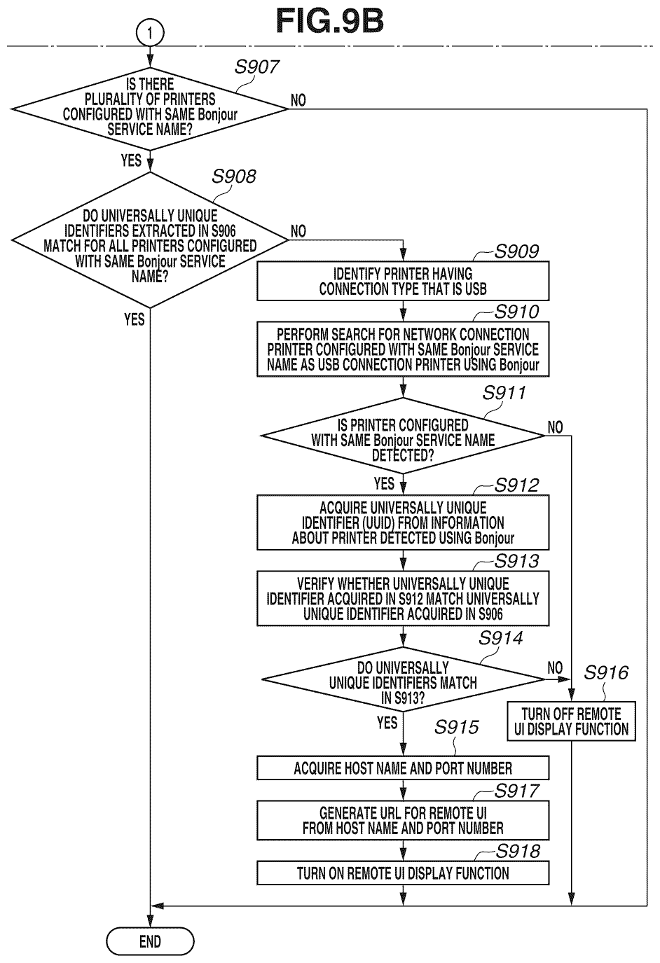

As an example of a process realized by the printer portal application 211, a process of acquiring the port number and host name of a USB printer, generating a URL for a remote UI, and turning on the remote UI display function will be described with reference to FIG. 9. Further, the process illustrated in FIG. 9 will be described also with reference to FIG. 10, which illustrates an example of a remote UI display screen. Although software and a function block may be described as a processing component for convenience, in practice, the corresponding function may be realized by the CPU 101 executing the corresponding program.

The processes from step S901 to step S908 are substantially the same as the processes from step S301 to step S308 in the first embodiment described above with reference to FIG. 3, so that detailed descriptions thereof will be omitted. Thereafter, in the present embodiment, in a case where the printer portal application 211 determines that at least some of the universally unique identifiers of the plurality of printers configured with the same Bonjour® service name do not match (NO in step S908), the processing proceeds to step S909.

In step S909, the printer portal application 211 identifies a USB connection printer from the plurality of printers determined to have been configured with the same Bonjour® service name in step S908. Examples of a method for distinguishing the connection type include a method for distinguishing between a network connection and a USB connection based on the Scheme component of the Device URI acquired in step S904. This method is not intended to be limiting, and any method capable of distinguishing the connection type of the target printer may be used.

In step S910, the printer portal application 211 specifies the same Bonjour® service name as that of the USB connection printer identified in step S909 and a character string indicating a network connection as a service type and performs a printer search using Bonjour®. This makes it possible to search for a network connection printer configured with the same Bonjour® service name as that of the USB connection printer identified in step S909, using Bonjour®. At this time, the domain name extracted in step S905 may be added to the search condition in addition to the Bonjour® service name during the printer search using Bonjour®.

In step S911, the printer portal application 211 determines whether a target printer, i.e., a network connection printer configured with the same Bonjour® service name as that of the USB connection printer identified in step S909, is detected in step S910.

In a case where the printer portal application 211 determines that a target printer is not detected (NO in step S911), the processing proceeds to step S916. In this case, it is difficult to use the function that displays the remote UI that enables printer configuration via a network. Accordingly, in step S916, the printer portal application 211 turns off the remote UI display function, and the process illustrated in FIG. 9 is terminated.

On the other hand, in a case where the printer portal application 211 determines that a target printer is detected (YES in step S911), the processing proceeds to step S912.

In step S912, the printer portal application 211 identifies the universally unique identifier of the network connection printer detected using Bonjour® in step S910 from information about the detected network connection printer.

In step S913, the printer portal application 211 verifies whether the universally unique identifier of the network connection printer acquired in step S912 matches the universally unique identifier acquired in step S906 for the USB connection printer identified in step S909.

In step S914, the printer portal application 211 determines whether the universally unique identifiers of the network connection printer and the USB connection printer match, as a result of the verification in step S913.

In a case where the printer portal application 211 determines that the universally unique identifiers of the network connection printer and the USB connection printer do not match (NO in step S914), the processing proceeds to step S916. In step S916, the printer portal application 211 turns off the remote UI display function, and the process illustrated in FIG. 9 is terminated.

On the other hand, in a case where the printer portal application 211 determines that the universally unique identifiers of the network connection printer and the USB connection printer match (YES in step S914), the processing proceeds to step S915.

In step S915, the printer portal application 211 acquires the host name and port number of the USB connection printer identified in step S909. The host name and port number of the target printer may be acquired using, for example, a function provided by the OS. Specifically, for example, in a case where the target OS is macOS, a standard application programming interface (standard API) for acquiring the host name and port number of the target printer is provided. This method is not intended to be limiting, and any method capable of acquiring the host name and port number of the target printer may be used.

In step S917, the printer portal application 211 generates a URL for the remote UI from a combination of the host name and port number acquired in step S915 and a predetermined fixed-format character string. The URL for the remote UI is composed of a character string 1301, which is made up of a combination of a host name and a port number, and a fixed-format character string 1302, as illustrated in FIG. 13. Accordingly, the URL for the remote UI can be generated by embedding the target host name, port number, and fixed-format character string into a URL template. For the USB connection printer, since the printer information acquired in step S909 does not include the URL for the remote UI, it is difficult to acquire the URL for the remote UI from the information. Even in this situation, the method described as the process of step S917 makes it possible to acquire the URL (access information) for the remote UI of the target USB connection printer. Further, even in a situation where a connection type other than a network connection is used, including but not limited to a USB connection, if the printer information is managed similarly, the corresponding device (such as a printer) may be set as a processing target as in the case of a USB connection.

In step S918, since the remote UI of the target USB connection printer can be displayed using the URL generated in step S917, the printer portal application 211 turns on the remote UI display function.

As described above, according to the present embodiment, the use of some of the functions (the remote UI display function) that are subject to usage restrictions can be enabled without requiring the user to change the Bonjour® service name.

### Other Embodiments

Embodiments of the present disclosure can also be realized by a process in which a program for realizing one or more functions of the above-described embodiments is supplied to a system or apparatus via a network or storage medium and one or more processors of a computer of the system or apparatus read the program and execute the read program. Further, embodiments of the present disclosure can be realized by a circuit (such as an application-specific integrated circuit (ASIC)) that realizes the one or more functions.

Further, although the above-described embodiments describe examples of cases where the technology referred to as Bonjour® is used to detect a printer, this is not intended to limit the scope of application of the technology according to the present disclosure. Specifically, the technology according to the present disclosure is also applicable even in a case where the detection target is an external device of a different type, including but not limited to printers. Further, the technology according to the present disclosure is also applicable in any situation where a function that detects a target external device using a service name assigned to the external device is used, including but not limited to Bonjour®.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-153692, which was filed on Sep. 6, 2024 and which is hereby incorporated by reference herein in its entirety.

What is claimed is:

1. A control method of an information processing apparatus, the control method comprising:
acquiring a plurality of zero-configuration-networking-service names registered in the information processing apparatus; and
issuing, based on a fact that a first zero-configuration-networking-service name and a second zero-configuration-networking-service name match, a notification to prompt a user to change a zero-configuration-networking-service name of at least one of a first communication apparatus having the first zero-configuration-networking-service name and a second communication apparatus having the second zero-configuration-networking-service name, wherein the first zero-configuration-networking-service name and the second zero-configuration-networking-service name are from among the plurality of zero-configuration-networking-service names.

2. The control method according to claim 1, further comprising determining, in a case where the first zero-configuration-networking-service name and the second zero-configuration-networking-service name match, whether a universally unique identifier of the first communication apparatus and a universally unique identifier of the second communication apparatus match,
wherein control is performed so that in a case where the universally unique identifier of the first communication apparatus and the universally unique identifier of the second communication apparatus do not match, the notification is issued, and in a case where the universally unique identifier of the first communication apparatus and the universally unique identifier of the second communication apparatus match, the notification is not issued.

3. The control method according to claim 2,
wherein, in a case where the first communication apparatus and the second communication apparatus are the same communication apparatus and the information processing apparatus is connected to the same communication apparatus via both a local area network (LAN) and a universal serial bus (USB), the universally unique identifier of the first communication apparatus and the universally unique identifier of the second communication apparatus match, and
wherein, in a case where the first communication apparatus and the second communication apparatus are separate communication apparatuses and the information processing apparatus is connected to the first communication apparatus via a LAN and is connected to the first communication apparatus via a USB, the universally unique identifier of the first communication apparatus and the universally unique identifier of the second communication apparatus do not match.

4. The control method according to claim 1, further comprising:
identifying a LAN connection apparatus currently or previously connected to the information processing apparatus via a LAN from the first communication apparatus and the second communication apparatus in a case where the first zero-configuration-networking-service name and the second zero-configuration-networking-service name match;
searching for the LAN connection apparatus after the notification is issued; and
communicating with the LAN connection apparatus in a case where the LAN connection apparatus is detected.

5. The control method according to claim 1, wherein control is performed so that in a case where the first zero-configuration-networking-service name and the second zero-configuration-networking-service name do not match, the notification is not issued.

6. The control method according to claim 1, wherein the plurality of zero-configuration-networking-service names is acquired by a predetermined application program of the information processing apparatus in a case where the predetermined application program is launched.

7. The control method according to claim 1, wherein the plurality of zero-configuration-networking-service names is acquired in a case where a button is operated to display a screen for changing a setting for one of a plurality of communication apparatuses corresponding to the plurality of zero-configuration-networking-service names registered in the information processing apparatus.

8. The control method according to claim 1, wherein the plurality of zero-configuration-networking-service names is acquired from an operating system (OS) of the information processing apparatus.

9. The control method according to claim 1, further comprising displaying a screen for changing a setting for the first communication apparatus after the notification is issued.

10. The control method according to claim 1, further comprising displaying a first screen for changing a setting for the first communication apparatus after the notification is issued.

11. The control method according to claim 10, further comprising:
performing a search for the first communication apparatus using the first zero-configuration-networking-service name after the notification is issued; and
acquiring information for displaying the first screen in a case where the first communication apparatus is detected by the search,
wherein the first screen is displayed based on the information for displaying the first screen.

12. The control method according to claim 10, wherein information for displaying the first screen is acquired from an operating system (OS) of the information processing apparatus.

13. The control method according to claim 12,
wherein the first communication apparatus and the second communication apparatus are printers, and
wherein the information for displaying the first screen is information included in printer queue information.

14. The control method according to claim 10, wherein the first screen is a screen for changing the zero-configuration-networking-service name of the first communication apparatus.

15. The control method according to claim 1, wherein the notification is a process of displaying a notification screen to prompt the user to change the zero-configuration-networking-service name of at least one of the first communication apparatus and the second communication apparatus.

16. The control method according to claim 1, wherein the zero-configuration-networking-service name is Bonjour® service name.

17. The control method according to claim 16, wherein the method includes at least one of a method in which an operation to change the zero-configuration-networking-service name is performed on at least one of the first communication apparatus and the second communication apparatus and a method in which an operation is performed on a predetermined screen that is a screen for changing the zero-configuration-networking-service name of at least one of the first communication apparatus and the second communication apparatus and displayed by the information processing apparatus.

18. The control method according to claim 1,
wherein the first communication apparatus is a LAN connection apparatus currently or previously connected to the information processing apparatus via a LAN, and
wherein the second communication apparatus is a USB connection apparatus currently or previously connected to the information processing apparatus via a USB.

19. A non-transitory computer-readable storage medium storing instructions that cause a computer of an information processing apparatus to execute a control method comprising:
acquiring a plurality of zero-configuration-networking-service names registered in the information processing apparatus; and
issuing, based on a fact that a first zero-configuration-networking-service name and a second zero-configuration-networking-service name match, a notification to prompt a user to change a zero-configuration-networking-service name of at least one of a first communication apparatus having the first zero-configuration-networking-service name and a second communication apparatus having the second zero-configuration-networking-service name, wherein the first zero-configuration-networking-service name and the second zero-configuration-networking-service name are from among the plurality of zero-configuration-networking-service names.

20. An information processing apparatus comprising:
at least one processor; and
at least one memory that is in communication with the at least one processor, wherein the at least one memory stores instructions for causing the at least one processor and the at least one memory to:
acquire a plurality of zero-configuration-networking-service names registered in the information processing apparatus; and
issue, based on a fact that a first zero-configuration-networking-service name and a second zero-configuration-networking-service name match, a notification to prompt a user to change a zero-configuration-networking-service name of at least one of a first communication apparatus having the first zero-configuration-networking-service name and a second communication apparatus having the second zero-configuration-networking-service name, wherein the first zero-configuration-networking-service name and the second zero-configuration-networking-service name are from among the plurality of zero-configuration-networking-service names.
